(19) United States
(12) Patent Application Publication
(10) Pub. No.: US 2019/0138965 A1
(43) Pub. Date: May 9, 2019

(54) METHOD AND SYSTEM FOR PROVIDING END-TO-END INTEGRATIONS USING INTEGRATOR EXTENSIBLE MARKUP LANGUAGE

(71) Applicant: Sreedhara Srinivasulu NARAYANASWAMY, Bangalore (IN)

(72) Inventor: Sreedhara Srinivasulu NARAYANASWAMY, Bangalore (IN)

(21) Appl. No.: 16/091,979

(22) PCT Filed: Apr. 6, 2017
(86) PCT No.: PCT/IN2017/050133

§ 371 Date: Oct. 6, 2018

(30) Foreign Application Priority Data
Apr. 6, 2016 (IN) 201641012113

(51) Int. Cl. G06Q 10/06; G06F 16/958

(52) U.S. Cl. CPC G06Q 10/06316; G06F 16/986

(57) ABSTRACT

The present invention provides an integrator as a service (IaaS) in an extensible markup language (XML) format for unifying multiple business processes, products and solutions to deliver comprehensive value to customers. The present invention provides software as a service (SaaS) based integration engine, pluggable modules for information technology management services, decision patterns based on business rules and process templates, business analytics and reporting. The present invention provides an integrator extensible markup language. The integrator extensible markup language is used for integration of applications, products, solutions, and processes. The present invention enables the integrator extensible markup language to include information regarding end-to-end integrations for a target end-deployment and infrastructure.

### FIELD OF THE INVENTION

The present invention generally relates to integrations in information technology management areas and more particularly to a method and system for providing end-to-end integrations of applications, products, solutions and processes using integrator extensible markup language.

### BACKGROUND TO THE INVENTION

In todays' world enterprise management systems orchestrates business processes. Enterprises deploy applications, products, solutions, and processes at each level in the organization in order to carry out smooth functioning of the business. Importantly, activities that the Enterprise users perform are dependent on communication and information. Information is key to decision making; whether customer wants to buy a product or business wants to procure specific quantity of raw materials or any other activity information can determine outcomes. Communication is an important channel for conveying information as well as for enabling interactions whether its group decision making or purposeful social interaction and in many other functions.

Naturally, enterprise systems have to communicate with multiple products, applications, solutions and processes for information and thus integration of all these channels becomes a necessity. The integration is typically performed in defined management areas of information technology (IT), financial, education, and other enterprise sectors. Currently, integrations are done independently towards the applications, products, solutions, or processes. Such integrations are tedious, time-consuming, and expensive. Moreover, currently available integration solutions are not designed to provide a birds' eye view to the enterprise users' in an executive role.

Therefore, there exists a need for an integration platform that enables multi-echelon integration of applications, products, solutions and processes into a single knowledgebase.

### SUMMARY OF THE INVENTION

This summary is provided to introduce a selection of concepts in a simplified format that are further described in the detailed description of the invention. This summary is not intended to identify key or essential inventive concepts of the subject matter, nor is it intended for determining the scope of the invention.

The present invention provides an integrator as a service (IaaS) in an extensible markup language (XML) format for unifying integrations of multiple business processes, products and solutions to deliver comprehensive value to customers.

The present disclosure discloses a method and system for providing end-to-end integrations using integrator extensible markup language, the method comprising, extracting business process information from an interface, deriving one or more functions, business rules, identifying applications, products, solutions and processes operational in the enterprise, generating a map of integration parameters, dynamic workflow parameters, target deployment procedures and target infrastructure parameters from the derived metadata, and consolidating, the map of integration parameters, the dynamic workflow parameters, the target deployment procedures and the target infrastructure parameters for generating an XML file, deploying the generated XML file on an enterprise server to provide end to end integration of the applications, products, processes and solutions.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE FIGURES

The invention will be described and explained with additional specificity and detail with the accompanying figures in which:

FIG. 1 illustrates an architecture for deploying XML Integrator as a service platform in accordance with embodiments of the present disclosure;

FIG. 2 is a block diagram illustrating one or more components of the IaaS platform, in accordance with embodiments of the present disclosure;

FIG. 3 is a schematic diagram illustrating generation of an integrator extensible markup language, in accordance with an embodiment;

FIG. 4 is a schematic diagram illustrating mapping during integration, in accordance with embodiments of the present disclosure;

FIG. 5 is a schematic diagram illustrating product, process and solution integration, in accordance with embodiments of the present disclosure;

FIG. 6 is a schematic diagram illustrating generation of a master extensible markup language using integrator as a service (IaaS) platform, in accordance with embodiments of the present disclosure;

FIG. 7 is a schematic diagram illustrating a integration markup language generated using integrator as a service (IaaS) platform, in accordance with an embodiment; and

FIG. 8 illustrates a block diagram of an electronic device, in accordance with one embodiment;

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DESCRIPTION OF THE INVENTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

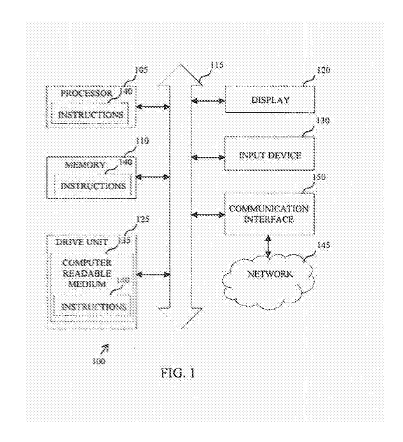

FIG. 1 illustrates an environment for deploying the enterprise level integration using Integration as a service (IaaS) platform in accordance with embodiments of the present disclosure. The terms ‘Integrator engine’, ‘Integration engine’, ‘XML Integrator’ and ‘Integration as a service (IaaS) platform’ are used interchangeably throughout the description and refer to the enterprise level integration providing mechanism of the present disclosure. In one embodiment, the integrator engine is hosted on an enterprise server and is available as a web application or a desktop application. In another embodiment, the integrator engine or the IaaS platform is hosted on a cloud infrastructure and is available for one or more enterprise users in a multi-tenant model as is known in the art. The integrator engine of the present disclosure further comprises machine learning algorithms and functionalities to extract information from one or more resources based on the Information Technology Infrastructure Library (ITIL) that focuses on aligning IT services with the needs of an enterprise. More particularly, the integrator engine is configured to extract and integrate one or more applications, products, processes and solutions of an enterprise with an objective to meet availability management, capacity management, incident management and problem management to ensure that the required levels and quality of service are achieved within the resources agreed.

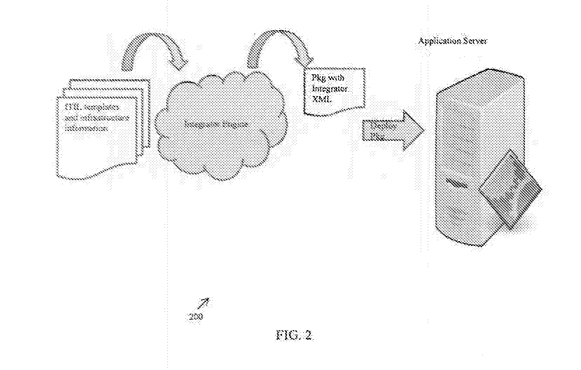

Now referring to FIG. 2, a block diagram of a system 200 for operating integration engine or IaaS Platform in accordance with embodiments of the present disclosure is illustrated. The system 200 comprises an electronic device 205 communicatively connected to the integrator engine 210 of the present disclosure. The electronic device 205 is associated with and operable by a user of the integrator engine 210. In an exemplary embodiment, the user of the electronic device 205 operates the integrator engine 210 as a web application. In FIG. 2, information transformation libraries (ITIL) templates and infrastructure information is generated by the integration as a service (IaaS) platform. The ITIL templates and infrastructure information is provided to an integration engine. The integration engine generates a master integrator XML that includes integrated information regarding applications, products, solutions, processes and deployment. The master integrator XML is further deployed into an application server.

Further, as shown in FIG. 2, the integrator engine 210 comprises a business rules extractor module, an integration map generator module, a dynamic work flow generator module and at least a metadata storage module. The integration engine 210 is configured to receive business process information from the user of the electronic device 205 in one or more pre-defined templates. The one or more pre-defined templates are in the form of a Microsoft Word document, a text file, a spreadsheet, an HTML page presented as a user interface and the like.

A file comprising business process information is then processed by a business rule generator module, to extract one or more business rules from the business profile information. In one embodiment, the business rule generator module is configured to execute semantic analysis algorithms to retrieve one or more business rules. In another embodiment, the business rules generator is configured to match the business process information received from the user of the electronic device 205 with one or more pre-defined templates of the ITIL to extract one or more business rules from the business process information.

In one embodiment, the integrator engine 210 is further configured to retrieve a list of applications, products, processes and solutions from the business process information. The list of applications, products, processes and solutions are then mapped with the conditional statements of the business rules by a map generator module of the integrator engine 210 to identify one or more integration parameters for each of the one or more applications, products, processes and solutions. The map generator further generates a complete list of mapping in a top to bottom approach or bottom up approach thereby providing a definite pattern of the integration.

In one embodiment, the integrator engine 210 of the present disclosure is further configured to execute one or more algorithms to recommend alternative applications, products, processes and solutions to the enterprise user of the integrator engine 210.

Further, a dynamic workflow generator module creates links between plurality of integration parameters and generates a communication flow between the integration parameters associated with plurality of applications, products, services and processes. In one embodiment, the dynamic workflow generator captures the plurality of APIs, Restful APIs, SOAs (service oriented architecture), etc. used to integrate the one or more applications, products, processes and solutions with one or more third party applications deployed by a vendor, a consumer and the like.

The system further comprises a configuration management database (CMDB) 215 is configured to generate configuration items for each of the integration for the application, the product, the solution, and the process. The CMDB generator also maintains a version control of changes in integration end-to-end lifecycle, thus enabling the enterprise user to switch to various versions of the integration during enterprise life cycle and manage legacy systems appropriately. The configuration management database 215 is communicatively connected to the integrator engine 210.

The system described can be implemented by software programs executable by an electronic device. Further, in a non-limited example, implementations can include distributed processing, component/object distributed processing, and parallel processing. Alternatively, virtual electronic device processing can be constructed to implement various parts of the system.

The system is not limited to operation with any particular standards and protocols. For example, standards for Internet and other packet switched network transmission (for example, TCP/IP, UDP/IP, HTML, HTTP) can be used. Such standards are periodically superseded by faster or more efficient equivalents having essentially the same functions. Accordingly, replacement standards and protocols having the same or similar functions as those disclosed are considered equivalents thereof.

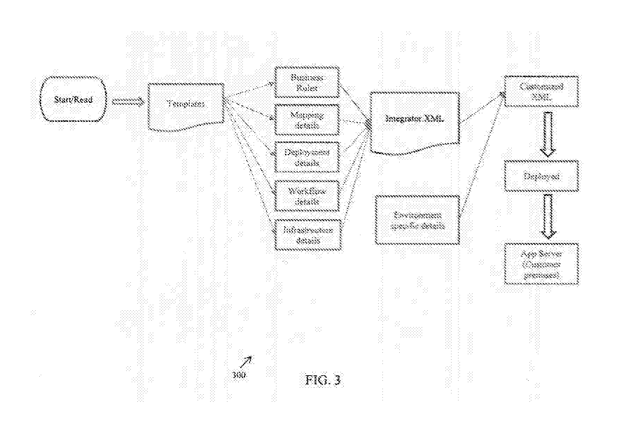

FIG. 3 is a schematic diagram 300 illustrating a method for providing enterprise level integration using an integrator extensible markup language (XML), in accordance with embodiments of the present disclosure.

In one embodiment of the present disclosure, the IaaS receives a text document from an enterprise for which the integrated XML file needs to be created. For example a word document comprising business process information associated with the enterprise is received, wherein the business process information is defined a pre-defined format. The business process information may include but not limited to the type of business, vendor details, client details, various processes involved in conducting the business, details about various applications used by the vendors, the clients and the enterprise, functions of the vendors and clients, product information, solutions and business rules. Such business process information is processed to generate an integrated/integrator XML file and the process is further described in detail referring to subsequent figures.

The method comprises the steps of receiving the business process information from the enterprise user in one or more pre-defined templates or a Microsoft Word document, a text file, a spreadsheet and the like. A word document processor used in the IaaS platform extracts information from the word document that describes the business process information associated with the enterprise. As described, the word documents typically includes type of business, vendor details, client details, various processes involved in conducting the business, details about various applications used by the vendors, the clients and the enterprise, functions of the vendors and clients, product information and business rules. In some implementations, macros are enabled by the word document processor which enables the end-user to provide other information related to integration. The word document processor also provides templates as shown, such that end-user can select a suitable template to provide the details of the integration.

A business rules extractor used in the IaaS platform then analyzes the content from the word document which has the details regarding the enterprise business process information. The business rule generator extracts business rules from the business process information (word document) and generates appropriate logical decision making rules.

A map generator used in the IaaS platform analyzes the content from the word document which has the details of the application, products, solution, process, and mapping parameters.

A work flow generator used in the IaaS platform analyzes the content from the word document which includes the details of the application, products, solution, and process integration. The work flow generator subsequently creates a dynamic work flow. The dynamic work flow enables an end-to-end integration process for communication pattern between the applications, products, solutions, and processes. In the integration pattern derived from the map generator, the work flow generator adds links between one or more applications, products, solutions and processes. Thus giving an indication of the communication pattern between plurality of applications, products, processes and solutions within the enterprise. In one embodiment, external links to third party applications via APIs, Restful APIs, SOAs and the like are also captured in the dynamic work flow generation.

A deployment generator used in the IaaS platform analyzes the content from the word document which includes the details of deployment environment parameters of various applications, products, solutions, and processes. The deployment generator further generates target deployment procedures. The deployment environment parameters are also saved in the form of metadata tags in a remote database.

An infrastructure generator used in the IaaS platform analyzes the content from the word document. The word documents includes the details regarding the deployment environment parameters of various applications, products, solutions, and processes related to target infrastructure parameters. Examples of the target infrastructure parameters include, but are not limited to, Windows, Linux, and MAC infrastructure.

An XML generator used in the IaaS platform consolidates an outcome of the word document processor, the business rule generator, the map generator, the work flow generator, the deployment generator, and the infrastructure generator into an XML file. The XML file includes the details of the company business rules, the mapping indicative of relationship between one or more entities, workflow between the one or more entities, deployment procedures and infrastructure parameters. The XML generator generates master integrator XML files which includes details of end-to-end integration of the application, the product, the solution, and the process.

The master integrator XML files thus constitutes the knowledgebase of the enterprise and may further be operated upon using machine learning algorithms to predict faulty behaviours at various levels of integration such as workflow procedures, deployment procedures, infrastructure parameters and the like. Furthermore, one or more machine learning algorithms may be used to recommend appropriate actions to the enterprise level administrator of IaaS platform to mitigate any faulty behaviours.

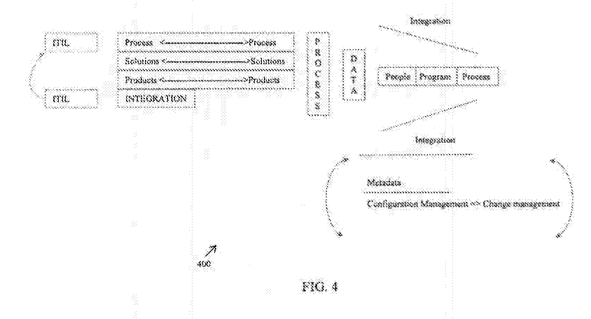

FIG. 4 is a schematic diagram 400 illustrating mapping during the integration process, in accordance with embodiments of the present disclosure. The mapping of process to process, solutions to solutions and products to products is illustrated in FIG. 4. In one example, for an enterprise undertaking the business of online travel booking, the mapping would be performed for the applications used by the enterprise such as a dashboard displaying availability of tickets for any destination with a plurality of vendors maintaining a repository of available tickets, similarly processes and solutions for payment failures would be created by integrating solutions from the payment gateways, facilitating banks and the consumer online travel booking application.

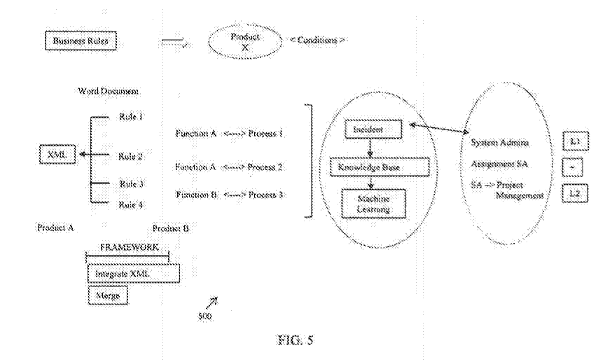

FIG. 5 is a schematic diagram 500 illustrating product integration, in accordance with an embodiment. Product integration, for example product A integrating with product B, is illustrated in FIG. 5. In some embodiments, based on a knowledge repository using machine language, decision making integration patterns can be created. Such integration can further be added to existing integrator XML. As shown in the FIG. 5, for a given product X, all the functions and conditions extracted by the business rules extractor is mapped and further, all the associated processes are linked to create XML tags. Further, the metadata retrieved from the business process information is captured by the XML integrator and included in the master integrator file in the form of tags for each of the one or more products.

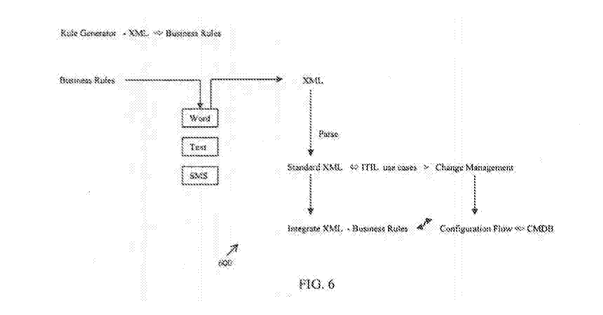

FIG. 6 is a schematic diagram 600 illustrating generation of a master integrator XML using the IaaS platform, in accordance with an embodiment. The master integrator XML which is generated and parsed to the standard XML from the IaaS platform is illustrated in FIG. 6.

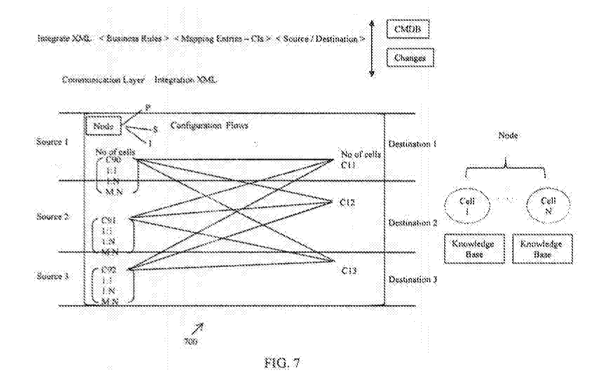

FIG. 7 is a schematic diagram 700 illustrating an integration markup language generated using the IaaS platform, in accordance with an embodiment. The integrator XML that includes details of the business rules, mapping entries, change items, source and destination integration parameters is illustrated in FIG. 7. The master integrator XML upon execution at the electronic device associated with the user provides a graphical representation of the end to end enterprise level integration of applications, products, processes and solutions used in the enterprise. Thus, the system and methods of the present disclosure enable real-time visualization of service level management, problem management, capacity management and incident management.

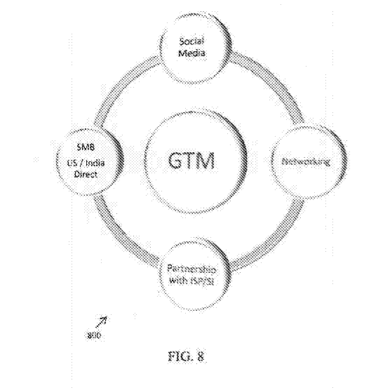

FIG. 8 illustrates an architecture of the electronic device 800 operated by a user of the IaaS Platform in accordance with embodiments of the present disclosure, which is representative of a hardware environment for practicing the present invention. The electronic device 800 can include a set of instructions that can be executed to cause the electronic device 800 to perform any one or more of the methods disclosed. The electronic device 800 may operate as a standalone device or can be connected, for example using a network, to other electronic devices or peripheral devices.

In a networked deployment of the present invention, the electronic device 800 may operate in a server-client user network environment, or as a peer electronic device in a peer-to-peer (or distributed) network environment. The electronic device 800 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single electronic device 800 is illustrated, the term “device” shall also be taken to include any collection of systems or sub-systems that individually or jointly execute a set, or multiple sets, of instructions to perform one or more computer functions.

The electronic device 800 can include a processor 805, for example a central processing unit (CPU), a graphics processing unit (GPU), or both. The processor 805 can be a component in a variety of systems. For example, the processor 805 can be part of a standard personal computer or a workstation. The processor 805 can be one or more general processors, digital signal processors, application specific integrated circuits, field programmable gate arrays, servers, networks, digital circuits, analog circuits, combinations thereof, or other now known or later developed devices for analyzing and processing data. The processor 805 can implement a software program, such as code generated manually (for example, programmed).

The electronic device 800 can include a memory 810, such as a memory 810 that can communicate via a bus 815. The memory 810 can include a main memory, a static memory, or a dynamic memory. The memory 810 can include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one example, the memory 810 includes a cache or random access memory for the processor 805. In alternative examples, the memory 810 is separate from the processor 805, such as a cache memory of a processor, the system memory, or other memory. The memory 810 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 810 is operable to store instructions executable by the processor 805. The functions, acts or tasks illustrated in the figures or described can be performed by the programmed processor 805 executing the instructions stored in the memory 810. The functions, acts or tasks are independent of the particular type of instructions set, storage media, processor or processing strategy and can be performed by software, hardware, integrated circuits, firm-ware, micro-code and the like, operating alone or in combination. Likewise, processing strategies can include multiprocessing, multitasking, parallel processing and the like.

As shown, the electronic device 800 can further include a display unit 820, for example a liquid crystal display (LCD), an organic light emitting diode (OLED), a flat panel display, a solid state display, a cathode ray tube (CRT), a projector, a printer or other now known or later developed display device for outputting determined information. The display 820 can act as an interface for a user to see the functioning of the processor 805, or specifically as an interface with the software stored in the memory 810 or in a drive unit 825.

Additionally, the electronic device 800 can include an input device 830 configured to allow the user to interact with any of the components of the electronic device 800. The input device 830 can include a stylus, a number pad, a keyboard, or a cursor control device, for example a mouse, or a joystick, touch screen display, remote control or any other device operative to interact with the electronic device 800.

The electronic device 800 can also include the drive unit 825. The drive unit 825 can include a computer-readable medium 835 in which one or more sets of instructions 840, for example software, can be embedded. Further, the instructions 840 can embody one or more of the methods or logic as described. In a particular example, the instructions 840 can reside completely, or at least partially, within the memory 810 or within the processor 805 during execution by the electronic device 800. The memory 810 and the processor 805 can also include computer-readable media as discussed above.

The present invention contemplates a computer-readable medium that includes instructions 840 or receives and executes the instructions 840 responsive to a propagated signal so that a device connected to a network 845 can communicate voice, video, audio, images or any other data over the network 845. Further, the instructions 845 can be transmitted or received over the network 845 via a communication port or communication interface 850 or using the bus 815. The communication interface 850 can be a part of the processor 805 or can be a separate component. The communication interface 850 can be created in software or can be a physical connection in hardware. The communication interface 850 can be configured to connect with the network 845, external media, the display 820, or any other components in the electronic device 800 or combinations thereof. The connection with the network 845 can be a physical connection, such as a wired Ethernet connection or can be established wirelessly as discussed later. Likewise, the additional connections with other components of the electronic device 800 can be physical connections or can be established wirelessly. The network 845 can alternatively be directly connected to the bus 815.

The network 845 can include wired networks, wireless networks, Ethernet AVB networks, or combinations thereof. The wireless network can include a cellular telephone network, an 802.11, 802.16, 802.20, 802.1Q or WiMax network. Further, the network 845 can be a public network, such as the Internet, a private network, such as an intranet, or combinations thereof, and can utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the electronic device 800.

One or more examples described can implement functions using two or more specific interconnected hardware modules or devices with related control and data signals that can be communicated between and through modules, or as portions of an application-specific integrated circuit. Accordingly, the present system encompasses software, firmware, and hardware implementations.

Various embodiments disclosed herein provide numerous advantages by providing a method and system for providing end-to-end integrations using a single integrator extensible markup language. The present invention provides an integrator XML that enables integration of processes, products and solutions. The present invention allows business process integration and analysis. The present invention allows rapid implementation of business use cases, and is both customizable and extensible. The present invention leverages existing customer infrastructure, has lower total cost of ownership, and has ease of use. Further, the present invention provides decision patterns based on real time analytics. The present invention also provides integrated end-end business processes using existing infrastructure and solutions of customers. The present invention also provides ability to connect heterogeneous systems within an organization, provides ability to integrate products or solutions across different architectures and infrastructures, for example on premises and cloud. Moreover, the present invention provides data intelligence.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. A method for enterprise level application integration, the method comprising:
receiving business process information from an interface;
extracting one or more business rules, one or more integration parameters and metadata from the business process information;
generating a map of integration parameters for each of the one or more business rules;
generating a dynamic workflow in the map of integration parameters, wherein the dynamic workflow represents the communication between one or more products, processes, applications, solutions and target deployment procedures;
retrieving target infrastructure parameters metadata from the business process information; and
consolidating, the map of integration parameters, the dynamic workflow parameters, the target deployment procedures and the target infrastructure parameters for generating a master XML file;
deploying the generated master XML file to provide end to end integration of the applications, products, processes and solutions.

2. The method as claimed in claim 1, wherein the business process information is extracted from at least a text file, a Word file, a spreadsheet and an HTML file.

3. The method as claimed in claim 1, wherein the master XML file is deployed on one of an enterprise server, a cloud infrastructure or both.

4. The method as claimed in claim 1, wherein the map of integration parameters is generated by mapping the one or more business rules with the functions and processes associated with one or more applications, products and solutions operational at the enterprise.

5. The method as claimed in claim 1, wherein dynamic workflow further comprises linking one or more third party applications with a native enterprise level application via APIs, Rest APIs, SOAs and the like.

6. The method as claimed in claim 1, wherein the XML file upon execution provides a graphical representation of enterprise level status of one or more applications, products, processes and solutions.

6. The method as claimed in claim 1, wherein consolidating the map of integration parameters, the dynamic workflow parameters, the target deployment procedures and the target infrastructure parameters comprises the step of creating XML tags for the metadata retrieved from the business process information.

8. An enterprise level application integration system comprising:
a processor;
instructions stored on a computer readable medium and executed by the processor;
a user interface that receives business process information;
wherein the instructions cause:
extraction of one or more of business rules, applications, products, solutions and metadata from the business process information;
generating a map of integration parameters, dynamic workflow parameters, target deployment procedures and target infrastructure parameters from the extracted business process information; and
consolidating, the map of integration parameters, the dynamic workflow parameters, the target deployment procedures and the target infrastructure parameters for generating a master XML file;
deploying the generated XML file to provide end to end integration of the applications, products, processes and solutions.

9. The system as claimed in claim 8, wherein the system further comprises a configuration management database for storing the extracted metadata and plurality of versions of the master XML files for version control management.

10. The system as claimed in claim 8, wherein the system further comprises an electronic device associated with a user of the enterprise level application integration system for graphical representation of the enterprise level integration.
